(19) United States
(12) Patent Application Publication
(10) Pub. No.: US 2015/0138587 A1
(43) Pub. Date: May 21, 2015

(54) PRINTING SYSTEM, TERMINAL APPARATUS, AND PRINTER

(71) Applicant: Konica Minolta Inc., Tokyo (JP)

(72) Inventor: Naoko HIRAMATSU, Kyoto-shi (JP)

(21) Appl. No.: 14/540,638

(22) Filed: Nov. 13, 2014

(30) Foreign Application Priority Data
Nov. 15, 2013 (JP) 2013-237047

(51) Int. Cl. G06F 3/12; H04N 1/00; G06K 15/00

(52) U.S. Cl. CPC G06F 3/1208; G06F 3/1294; G06F 3/1292; G06K 15/005; H04N 1/0044; G06F 3/1284; G06F 3/1238; G06K 15/4095; H04N 2201/0094
USPC 358/1.14; 358/1.15

(57) ABSTRACT

A printing system includes a printer and a terminal device. The terminal device is provided to be able to communicate with the printer and transmits a job relating to print processing for a file which can be supported by the printer. The terminal device includes a controller determining whether or not print preview can be displayed on a display of the printer and a communication controller communicating to the printer, a print job including an indication for print preview in response to an indication when the controller determines that print preview can be displayed on the display of the printer. The printer displays on the display, print preview in accordance with the print job including the indication for print preview transmitted from the terminal device.

### CROSS REFERENCE

This application is based on Japanese Patent Application No. 2013-237047 filed with the Japan Patent Office on Nov. 15, 2013, the entire content of which is hereby incorporated by reference.

### BACKGROUND OF THE INVENTION

1. Field of the Invention

This disclosure relates to a printing system and to print preview in direct print (direct print processing) of a file.

2. Description of the Related Art

A method which is what is called direct print for having a printer print by directly transmitting a file from a terminal device which is a client to a printer not by way of a printer driver is available as a printing method in a printing system including a printer and a terminal device such as a personal computer (PC), a tablet apparatus, a portable terminal, or a digital camera. Direct print can obviate the need for installation of a printer driver in a terminal device. Direct print can also obviate the need for opening of a file at the time of printing.

How print on a terminal device looks is desirably checked at the time of direct print, an application for preview display installed in the terminal device is used to provide preview display of a result of print of a file.

Preview display based on an application for preview display (a viewer application (hereinafter also referred to as a viewer app.)) installed in a terminal device may greatly be different from how a printed matter from a printer looks.

This is because a scheme for interpretation of a file to be printed is different between a terminal device and a printer. The scheme for interpretation of a file by a terminal device is different based on a difference in an internal operating system (OS) or a difference in application.

Therefore, in order to carry out preview display consistent with a printed matter, there is a scheme for transmitting data to a printer which performs print processing, having the printer create data for preview display, transmitting data for preview display to a terminal device, and providing display based on the data. In this connection, Japanese Laid-Open Patent Publications Nos. 2003-84960 and 2006-163794 are exemplified.

### SUMMARY OF THE INVENTION

Constant transfer of data for preview display created by a printer to a terminal device, however, leads to heavy communication traffic and burden on a network.

The present disclosure was made in view of such problems, and an object is to provide a printing system capable of achieving lighter communication load on a network in preview display during direct print.

A printing system according to one aspect of the present disclosure includes a printer and a terminal device. The terminal device is provided to be able to communicate with the printer and transmits a job relating to print processing for a file which can be supported by the printer. The terminal device includes a controller determining whether or not print preview can be displayed on a display of the printer and a communication controller transmitting a print job including an indication for the print preview to the printer in response to an indication when the controller determines that the print preview can be displayed on the display of the printer. The printer displays on the display, print preview in accordance with the print job including the indication for the print preview transmitted from the terminal device.

The printer displays the print preview on the display in response to an input of the indication for start of the print preview.

In particular, the printer displays the print preview on the display in response to the input of the indication for start of the print preview from the terminal device.

In particular, the printer displays the print preview on the display in response to the input of the indication for start of the print preview onto an input portion of the printer.

In particular, the print job including the indication for the print preview transmitted from the terminal device is stored in a prescribed area of the printer, access to which requires authentication processing. The printer requests input of authentication information as the indication for start of the print preview onto the input portion of the printer, and displays the print preview on the display in accordance with the print job including the indication for the print preview stored in the prescribed area when the authentication processing is successful.

In particular, the print job including the indication for the print preview includes identification information identifying the terminal device which has transmitted the print job including the indication for the print preview. The input portion of the printer has a wireless communication portion provided to be capable of near field communication with the terminal device and obtaining identification information identifying the terminal device through the near field communication. The printer determines whether or not the obtained identification information of the terminal device matches with the identification information identifying the terminal device included in the print job including the indication for the print preview, and displays the print preview on the display in accordance with the print job including the indication for the print preview transmitted from the terminal device when the printer determines that they match with each other.

In particular, the communication controller transmits to the printer, the print job including the indication for the print preview associated with authentication information made use of for authentication processing in response to an indication when the communication controller determines that the print preview can be displayed on the display of the printer. The printer requests input of the authentication information as the indication for start of the print preview onto the input portion of the printer and displays the print preview on the display when the authentication processing is successful.

In particular, the terminal device displays password information requested in the authentication processing.

In particular, the password information is data registered in advance by a user in the terminal device.

Preferably, the controller of the terminal device accepts a selective input about whether the print preview is displayed on the display of the printer or the print preview is displayed based on a display function of the terminal device. The communication controller transmits to the printer, the print job including the indication for the print preview, with information indicating display of the print preview based on the display function of the terminal device being included, when the controller accepts display of the print preview based on the display function of the terminal device. The printer generates print preview data for display of the print preview in accordance with the information included in the print job including the indication for the print preview transmitted from the terminal device and transmits the print preview data to the terminal device for display of the print preview based on the display function of the terminal device.

Preferably, a server provided to be able to communicate with the printer and the terminal device, holding the print job including the indication for the print preview transmitted from the terminal device to the printer, and transmitting the print job to the printer in response to an indication is further provided.

A terminal device according to one aspect of the present disclosure is a terminal device provided to be able to communicate with a printer and transmitting a print job relating to print processing for a file which can be supported by the printer, which includes a controller determining whether or not print preview can be displayed on a display of the printer and a communication controller transmitting a print job including an indication for the print preview to the printer in response to an indication when the controller determines that the print preview can be displayed on the display of the printer.

A printer according to one aspect of the present disclosure is a printer provided to be able to communicate with a terminal device and receiving from the terminal device, a print job relating to print processing for a file which can be supported, which includes a display and a controller displaying the print preview on the display in accordance with a print job including an indication for the print preview transmitted from the terminal device when it is determined that the terminal device can display the print preview on the display.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram illustrating a configuration of a printing system based on the present embodiment.

FIG. 2 is a diagram showing a specific example of each apparatus based on the present embodiment.

FIG. 3 is a diagram illustrating relation between a viewer app. of a terminal device 300 and an MFP 100.

FIG. 4 is a diagram illustrating a case that preview display (print preview) and a printed matter are different depending on a type of a file.

FIG. 5 is a diagram illustrating a functional configuration of terminal device 300 based on a present first embodiment.

FIG. 6 is a diagram illustrating a print setting screen in carrying out direct print in the printing system based on the present first embodiment.

FIG. 7 is a flowchart illustrating processing for transmitting a print job in terminal device 300 based on the present first embodiment.

FIG. 8 is a diagram illustrating one example of a printing apparatus data list based on the present first embodiment.

FIG. 9 is a flowchart illustrating processing for receiving a print job in MFP 100 based on the present first embodiment.

FIG. 10 is a flowchart illustrating processing for receiving print preview data in terminal device 300 based on the present first embodiment.

FIG. 11 is a flowchart illustrating processing for transmitting a print job in terminal device 300 based on a modification of the present first embodiment.

FIG. 12 is a flowchart illustrating processing for transmitting a print job in terminal device 300 in a present second embodiment.

FIG. 13 is a diagram illustrating a preview display check screen based on the present second embodiment.

FIG. 14 is a flowchart illustrating processing for receiving a print job in MFP 100 based on the present second embodiment.

FIG. 15 is a diagram illustrating a print setting screen in carrying out direct print in the printing system based on a present third embodiment.

FIG. 16 is a flowchart illustrating processing for transmitting a print job in terminal device 300 based on the present third embodiment.

FIG. 17 is a flowchart illustrating processing for receiving a print job in MFP 100 based on the present third embodiment.

FIG. 18 is a diagram illustrating an authentication screen 410 based on the present third embodiment.

FIG. 19 is a diagram illustrating an authentication information notification screen based on a first modification of the present third embodiment.

FIG. 20 is a diagram illustrating a BOX area which is a prescribed area of MFP 100.

FIG. 21 is a diagram illustrating a wireless communication portion provided in the vicinity of an operation panel of MFP 100.

FIG. 22 is a flowchart illustrating processing for transmitting a print job in terminal device 300 based on a third modification of the present third embodiment.

FIG. 23 is a flowchart illustrating processing for receiving a print job in MFP 100 based on the third modification of the present third embodiment.

FIG. 24 is a flowchart illustrating processing for transmitting a print job in terminal device 300 based on a present fourth embodiment.

FIG. 25 is a diagram illustrating a printing system in coordination with a server.

### DESCRIPTION OF THE PREFERRED EMBODIMENTS

An embodiment of the present disclosure will be described hereinafter with reference to the drawings. In the description below, the same elements and components have the same reference characters allotted. Their label and function are also identical. Therefore, detailed description thereof will not be repeated.

### System Configuration

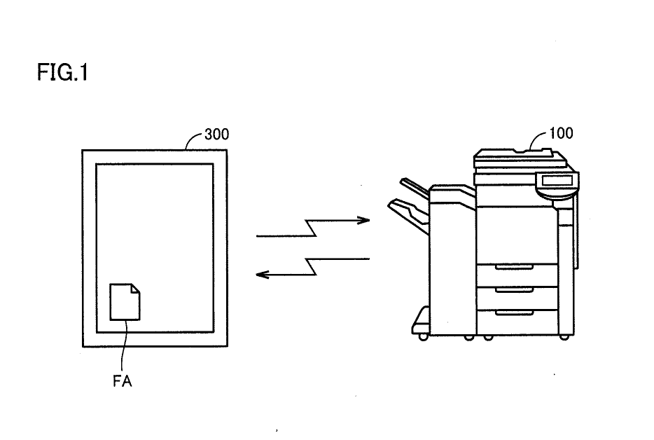

FIG. 1 is a diagram illustrating a configuration of a printing system based on the present embodiment.

Referring to FIG. 1, the printing system according to the present embodiment includes a multi-functional peripheral (MFP) 100 by way of example of a printer and a terminal device 300 by way of example of a client apparatus, which are connected wirelessly or via wire to be able to communicate. Terminal device 300 is exemplified, for example, by a personal computer (PC), a tablet apparatus, a portable terminal, or a digital camera.

In the present example, print processing for a file FA stored in terminal device 300 will be described. For file FA, direct print (direct print processing) in MFP 100 is supported.

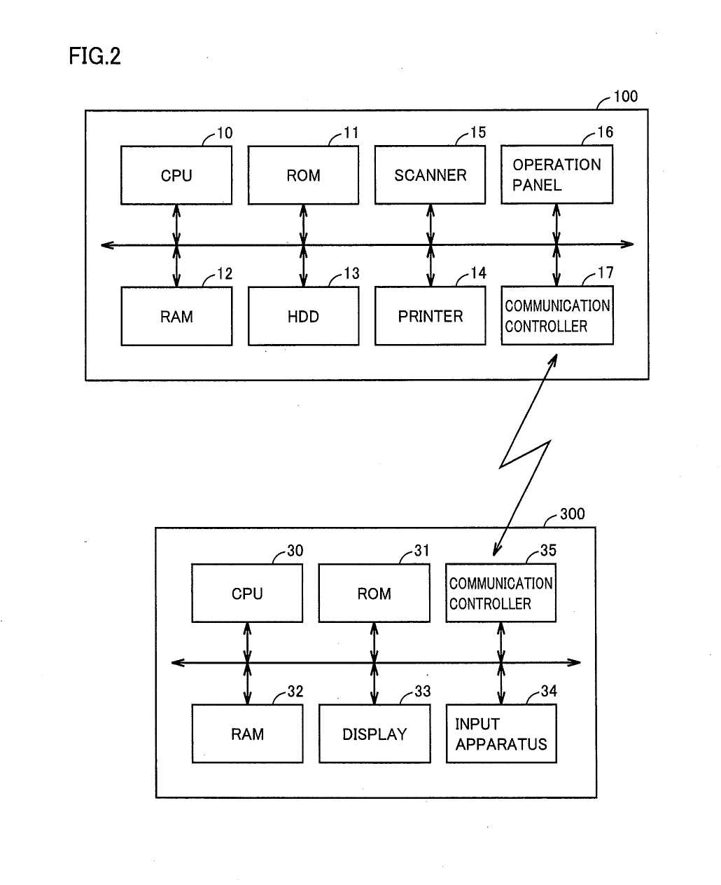

FIG. 2 is a diagram showing a specific example of each apparatus based on the present embodiment.

Referring to FIG. 2, MFP 100 includes a central processing unit (CPU) 10 for overall control of an apparatus, a read only memory (ROM) 11 which is a memory for storing a program executed by CPU 10, a RAM 12 which is a memory storing telephone directory data or serving as a working area for CPU 10 to execute a program, a hard disk drive (HDD) 13 which is a memory for storing image data, a printer 14, a scanner 15, an operation panel 16, and a communication controller 17 for controlling communication with terminal device 300.

Terminal device 300 includes a CPU 30 for overall control of an apparatus, a ROM 31 which is a memory for storing a program executed by CPU 30, a RAM 32 which is a memory storing various types of data or serving as a working area for CPU 30 to execute a program, a display 33, an input apparatus 34 such as a button, and a communication controller 35 for controlling communication with MFP 100.

### Difference in Preview Display

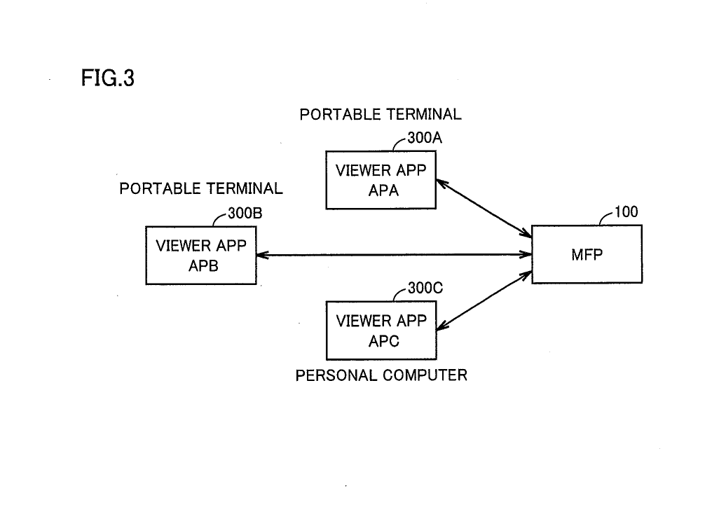

FIG. 3 is a diagram illustrating relation between a viewer app. of terminal device 300 and MFP 100.

Referring to FIG. 3, in the present example, by way of example, three terminal devices different in type are shown. Specifically, terminal devices 300A and 300B as terminal devices representing a portable terminal, a terminal device 300C as a personal computer representing a stationary terminal, and MFP 100 are provided to be able to communicate.

In terminal devices 300A, 300B, and 300C, viewer apps. APA, APB, and APC are installed, respectively.

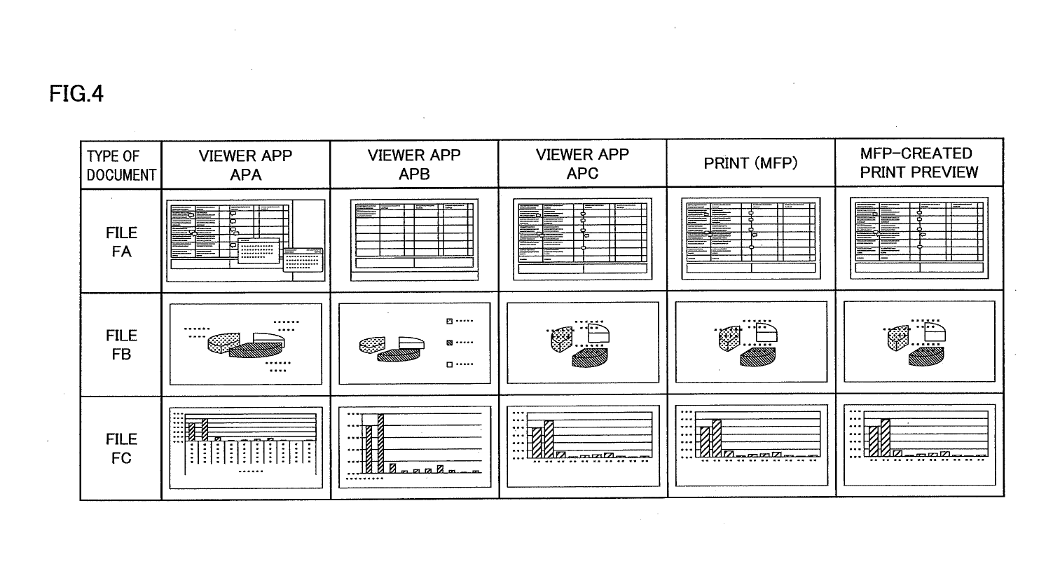

FIG. 4 is a diagram illustrating a case that preview display (print preview) and a printed matter are different depending on a type of a file.

As shown in FIG. 4, for example, file FA has table data and has annotations or comments added. A file FB has data of a circle graph. A file FC has data of a bar graph. Even the same file may be different in preview display due to difference in type of a viewer app. Difference from a printed matter from MFP 100 is also shown.

Though preview display by means of viewer app. APC produces a result the same as the printed matter, it is difficult to operate the application in terminal devices 300A and 300B because it is an application for a personal computer. Though preview display the same as the printed matter is provided in terminal device 300C which is a personal computer in the present example, it is not necessarily the same as the printed matter from MFP 100 and preview display may be different based on a difference in OS or application.

Therefore, in order to carry out preview display consistent with the printed matter on a terminal device such as a portable terminal by way of example, data should be transmitted to MFP 100 performing print processing, data for preview display should be created by MFP 100 (see MFP-created print preview), and data for preview display on terminal devices 300A and 300B which corresponds to a printed matter should be transmitted to the terminal devices.

When data for preview display created by the MFP is constantly transmitted to a terminal device as described above, however, heavy communication traffic takes place between terminal device 300 and MFP 100, which imposes burden on a network.

Therefore, in the present example, terminal device 300 determines whether or not MFP 100 can provide preview display, and when preview display can be provided, MFP 100 carries out preview display.

Thus, processing for transmitting data for preview display to terminal device 300 can be lessened.

### First Embodiment

### Functional Configuration

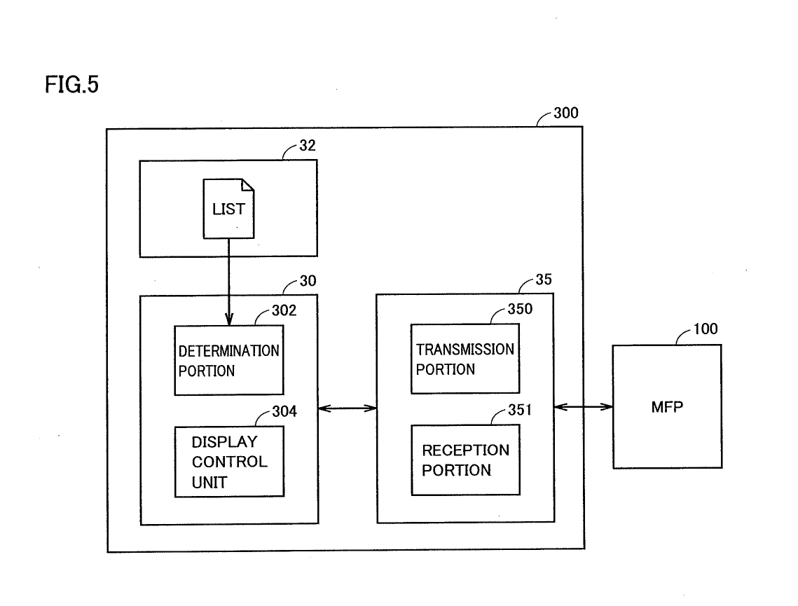

FIG. 5 is a diagram illustrating a functional configuration of terminal device 300 based on the present first embodiment.

As shown in FIG. 5, terminal device 300 includes CPU 30, RAM 32, and communication controller 35. CPU 30 includes a determination portion 302 and a display control unit 304. RAM 32 has a printing apparatus data list for identifying whether or not MFP 100 can provide preview display.

Communication controller 35 includes a transmission portion 350 and a reception portion 351. Transmission portion 350 receives data from CPU 30 and transmits the data to MFP 100. Reception portion 351 receives data from MFP 100 and outputs the data to CPU 30.

Determination portion 302 determines whether or not MFP 100 can provide preview display by referring to the printing apparatus data list stored in RAM 32 in carrying out preview display of file FA. When determination portion 302 determines that MFP 100 can provide preview display by way of example, it generates a print job including an indication instructing MFP 100 to carry out preview display and outputs the print job to transmission portion 350.

When determination portion 302 determines that MFP 100 cannot (is unable to) provide preview display by way of example, it instructs creation of data for preview display (print preview data) in MFP 100, generates a print job including an indication to transmit the print preview data to terminal device 300, and outputs the print job to transmission portion 350.

Transmission portion 350 transmits the print job from determination portion 302 including the indication to carry out preview display to MFP 100 by way of example. Alternatively, it transmits to MFP 100, the print job including an indication to transmit the print preview data to terminal device 300.

When reception portion 351 receives the print preview data from MFP 100 by way of example, it outputs the print preview data to display control unit 304.

Display control unit 304 has display 33 display the print preview data received by reception portion 351.

Each function of CPU 30 and communication controller 35 is implemented by execution of a program stored in ROM 31.

### Print Setting Screen

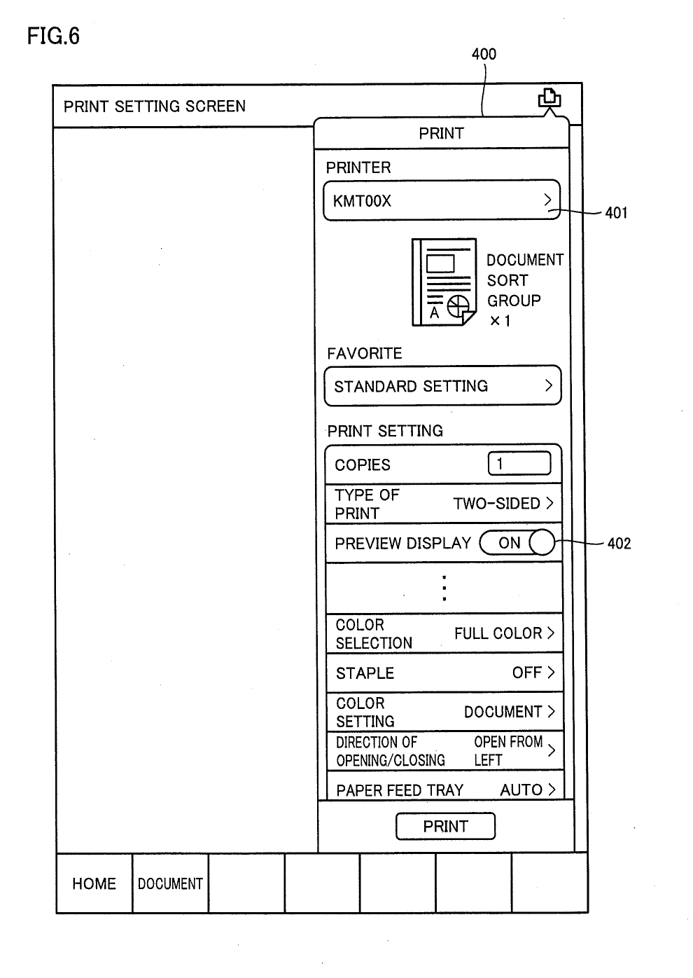

FIG. 6 is a diagram illustrating a print setting screen in carrying out direct print in the printing system based on the present first embodiment.

Referring to FIG. 6, a print setting screen 400 in carrying out direct print in terminal device 300 is shown. Print setting screen 400 is displayed by execution of a program for carrying out direct print stored in ROM 31.

A selection area 401 for selection of a printer name is provided in print setting screen 400, and when a plurality of printers are registered in advance in selection area 401, a printer to be used as a printing apparatus can be selected from among the printers. In the present example, “KMT00X” is selected as the printer name. Even when printers are not registered in advance, printers provided to be able to communicate may be retrieved and a printer may be selected from among the retrieved printers.

A slide button 402 for “preview display” is provided in print setting screen 400, and execution (on) and non-execution (off) of preview display can be indicated by laterally sliding the slide button.

In the present example, execution (ON) of preview display is indicated by operating slide button 402 so as to carry out direct print.

### Operation Outlines

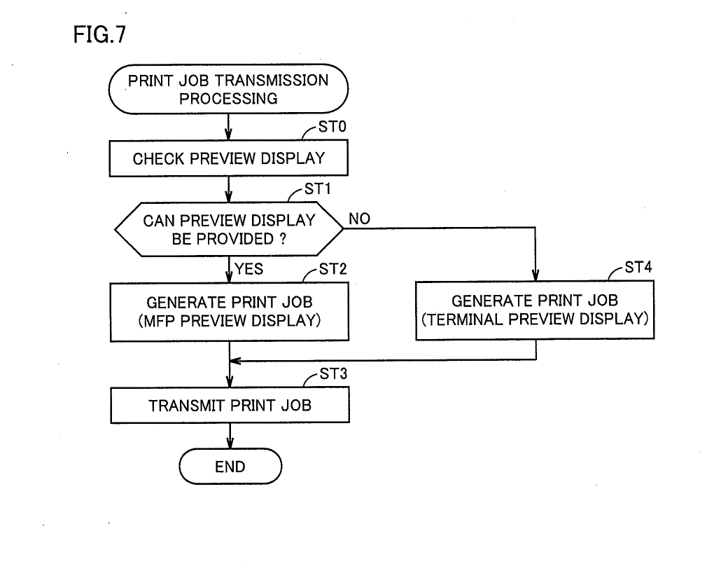

FIG. 7 is a flowchart illustrating processing for transmitting a print job in terminal device 300 based on the present first embodiment.

Referring to FIG. 7, the present printing system allows printing which is what is called direct print in which a file to be printed is directly transmitted for printing from terminal device 300 which is a client to MFP 100 not by way of a printer driver.

In the present example, execution of preview display is indicated in direct print of a file from terminal device 300 to MFP 100.

Namely, execution (on) of “preview display” is indicated by using slide button 402.

Initially, terminal device 300 checks information on preview display in MFP 100 (step ST0). Specifically, determination portion 302 obtains information on whether or not MFP 100 representing a printing apparatus can provide preview display, by referring to a data list stored in RAM 32.

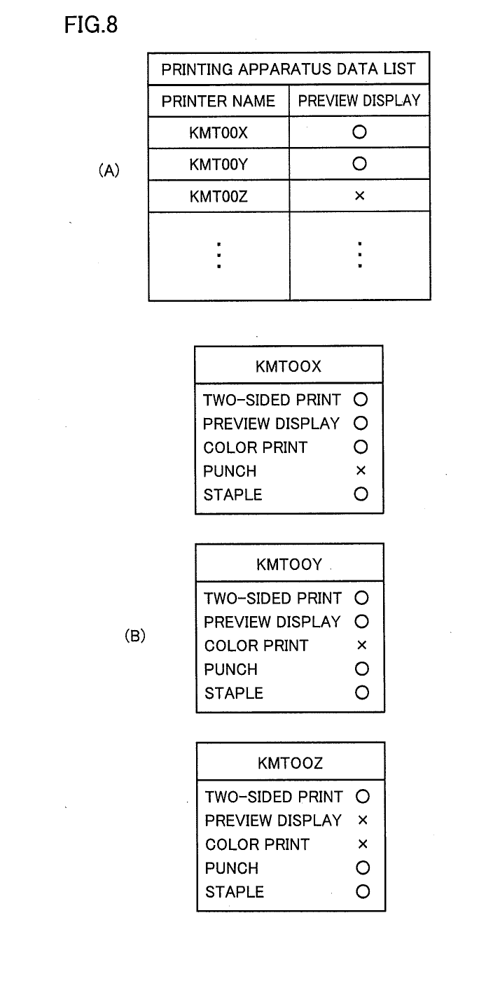

FIG. 8 is a diagram illustrating one example of a printing apparatus data list based on the present first embodiment.

Referring to FIG. 8 (A), in the present example, a printer name and ability to display preview are registered in correspondence with each other.

Specifically, in the present example, “KMT00X”, “KMT00Y”, and “KMT00Z” are registered as printer names, and “∘”, “∘”, and “x” are registered in advance in correspondence as ability to display preview, respectively. Though representation of “∘” and “x” is shown by way of example in the present example, limitation to the data is not particularly intended, and any data allowing identification of whether or not preview display can be provided may be applicable.

“∘” for preview display means that a printing apparatus has a display function and display based on preview data can be provided by making use of the display function.

Referring to the printing apparatus data list, whether or not preview display can be provided in MFP 100 which is a printing apparatus can be determined based on data of “∘” or “x” for preview display.

Though terminal device 300 has the printing apparatus data list in advance in the present example, the printing apparatus data list may be received, for example, from a not-shown external server.

Referring to FIG. 8 (B), in the present example, as a printing apparatus data list, an individual function list as information on a function of MFP 100 which is each printing apparatus can also be provided.

In the present example, a function list allowing determination as to whether or not each function of MFP 100 corresponding to a printer name can be made use of is shown in correspondence with each of the printer names “KMT00X”, “KMT00Y”, and “KMT00Z”.

As terminal device 300 has the function list in correspondence with each MFP 100, whether or not MFP 100 which is a printing apparatus can provide preview display can be determined based on the data on preview display “∘” or “x” by referring to the function list.

A function list created or held by each MFP 100 may be obtained by terminal device 300, a function list may be mastered by receiving the list from an external server, or a function list may directly be input to terminal device 300.

Referring again to FIG. 7, terminal device 300 determines whether or not MFP 100 which is a printing apparatus can provide preview display (step ST1).

Specifically, determination portion 302 determines whether or not MFP 100 can provide preview display based on the printing apparatus data list.

When terminal device 300 determines that preview display can be provided (YES in step ST1), it generates a print job including an indication to carry out preview display (step ST2). Specifically, determination portion 302 generates a print job including an instruction for preview instructing MFP 100 to carry out preview display. The print job includes, together with file data to be printed, an instruction (a command) instructing MFP 100 to provide preview display. The print job is also referred to as an MFP preview print job.

When terminal device 300 determines that preview display cannot be provided (NO in step ST1), it generates a print job including an indication for transmission of print preview data to terminal device 300 (step ST4). Specifically, determination portion 302 generates print preview data for carrying out preview display in terminal device 300 and generates a print job including an instruction indicating transmission to terminal device 300. The print job includes, together with file data to be printed, an instruction (a command) indicating generation of print preview data and transmission of the generated data to terminal device 300. The print job is also referred to as a terminal preview print job.

Then, terminal device 300 transmits the print job generated in determination portion 302 (step ST3). Specifically, transmission portion 350 transmits to MFP 100, an MFP preview print job or a terminal preview print job created by determination portion 302 (step ST3).

Then, the process ends (end).

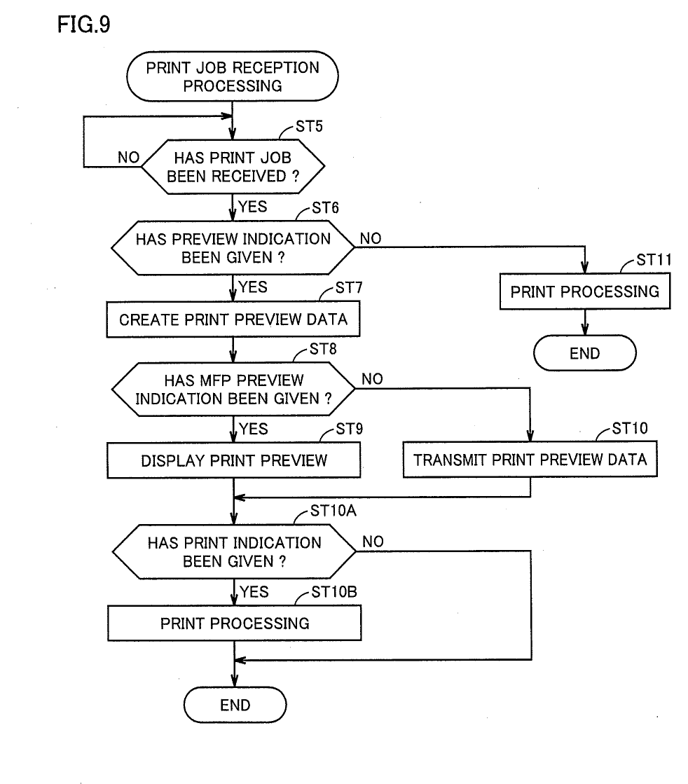

FIG. 9 is a flowchart illustrating processing for receiving a print job in MFP 100 based on the present first embodiment.

Referring to FIG. 9, MFP 100 determines whether or not a print job has been received (step ST5). Specifically, communication controller 17 in MFP 100 outputs the received print job (an MFP preview print job, a terminal preview print job, or a normal print job) to CPU 10. When MFP 100 determines in step ST5 that no print job has been received (NO in step ST5), it maintains a state in step ST5. When MFP 100 determines in step ST5 that a print job has been received (YES in step ST5), the process proceeds to step ST6.

Then, MFP 100 determines whether or not the print job includes a preview indication (step ST6). Specifically, CPU 10 determines whether a job is an MFP preview print job or a terminal preview print job.

When it is determined in step ST6 that there is no preview indication in the print job (NO in step ST6), the job is a normal print job and print processing is performed (step ST11).

Then, the process ends (end).

When MFP 100 determines in step ST6 that there is a preview indication (YES in step ST6), print preview data is created (step ST7). Specifically, CPU 10 creates print preview data based on a program stored in ROM 11 in accordance with file data and a command included in the MFP preview print job or the terminal preview print job.

Then, MFP 100 determines whether or not there is an indication for MFP preview (step ST8). Specifically, CPU 10 determines whether or not the print job received in accordance with the included command is the MFP preview print job.

When it is determined in step ST8 that there is an indication for MFP preview (YES in step ST8), MFP 100 displays print preview (step ST9). Specifically, CPU 10 has, for example, a not-shown display portion of operation panel 16 display created print preview data. Thus, MFP 100 can display print preview and an object to be printed can be checked in advance.

Then, whether or not there is a print indication is determined (step ST10A). Specifically, CPU 10 determines whether or not an input of a print indication through operation panel 16 has been received.

When it is determined in step ST10A that there is a print indication (YES in step ST10A), print processing is performed (step ST10B). Then, the process ends (end).

When it is determined in step ST10A that there is no print indication (NO in step ST10A), print processing is not performed and the process ends (end).

With the processing, print preview can be checked on MFP 100 and whether or not to perform print processing can be determined.

When it is determined in step ST8 that there is no indication for MFP preview (NO in step ST8), that is, when it is determined that a job is the terminal preview print job, MFP 100 transmits print preview data (step ST10). Specifically, CPU 10 transmits the created print preview data to terminal device 300 through communication controller 17. The print preview data is used for print preview in terminal device 300.

When it is determined in step ST10A that there is a print indication (YES in step ST10A), print processing is performed (step ST10B), Then, the process ends (end).

When it is determined in step ST10A that there is no print indication (NO in step ST10A), print processing is not performed and the process ends (end).

With the processing, print preview can be checked on terminal device 300 and whether or not print processing is performed can be determined.

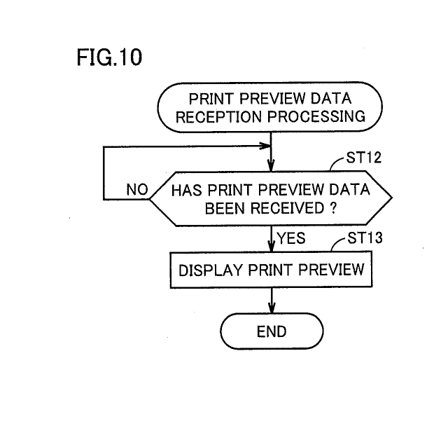

FIG. 10 is a flowchart illustrating processing for receiving print preview data in terminal device 300 based on the present first embodiment.

Referring to FIG. 10, terminal device 300 determines whether or not print preview data has been received (step ST12). Specifically, reception portion 351 of terminal device 300 determines whether or not print preview data has been received.

When terminal device 300 determines in step ST12 that no print preview data has been received (NO in step ST12), it maintains a state in step ST12.

When terminal device 300 determines in step ST12 that print preview data has been received (YES in step ST12), it displays print preview (step ST13). Specifically, display control unit 304 has display 33 display print preview based on the print preview data.

With the scheme, when MFP 100 can display print preview, MFP 100 carries out print preview, and when MFP 100 cannot (is unable to) carry out print preview, print preview data created by MFP 100 is transmitted to terminal device 300 for display of print preview.

Namely, in carrying out preview display consistent with a printed matter, whether or not MFP 100 can provide print preview display is determined, and when print preview can be displayed, MFP 100 carries out print preview. Therefore, it is not necessary to constantly transmit print preview data to terminal device 300, and communication load on a network in preview display during direct print can be lessened. When MFP 100 cannot provide print preview display, print preview data created by MFP 100 is transmitted to terminal device 300 for display of print preview. Therefore, terminal device 300 can provide preview display consistent with a printed matter.

(Modification)

In the first embodiment above, a scheme for determining whether or not a printing apparatus can provide preview display by referring to a printing apparatus data list has been described.

In a modification of the present first embodiment, a case that a terminal device does not have a printing apparatus data list will be described.

### Operation Outlines

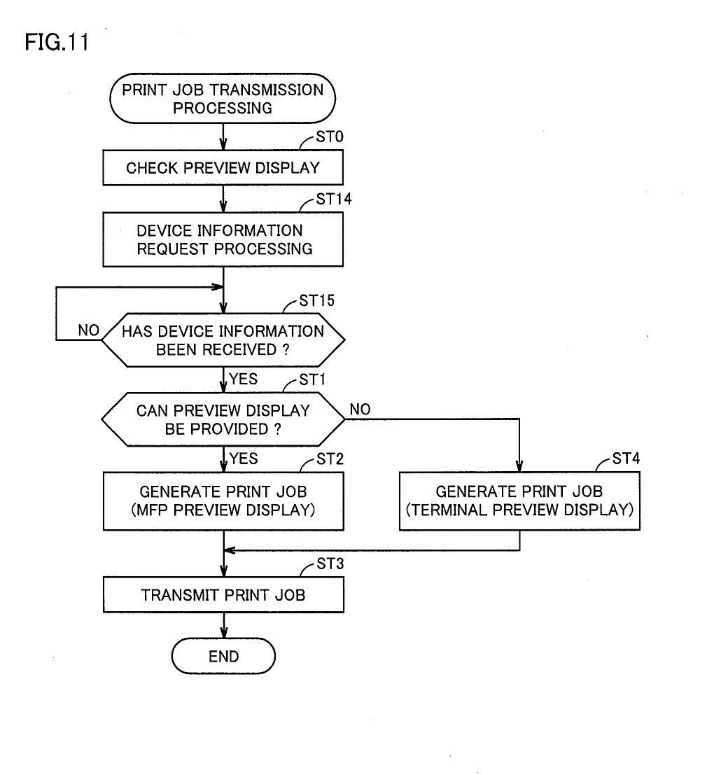

FIG. 11 is a flowchart illustrating processing for transmitting a print job in terminal device 300 based on the modification of the present first embodiment.

Referring to FIG. 11, the present process is different in additional steps ST14 and ST15. Since the process is otherwise the same as described with reference to FIG. 7, detailed description thereof will not be repeated.

Initially, terminal device 300 checks information on preview display in MFP 100 (step ST0).

Then, terminal device 300 performs processing for requesting device information from MFP 100 (step ST14). Specifically, determination portion 302 outputs a command requesting device information through transmission portion 350 to MFP 100.

Then, MFP 100 receives the command and outputs the device information to terminal device 300. Specifically, communication controller 17 in MFP 100 outputs a command requesting device information to CPU 10, and CPU 10 obtains the information from ROM 11 in response to the command requesting device information and transmits the information to terminal device 300 through communication controller 17.

Then, terminal device 300 determines whether or not device information from MFP 100 has been received (step ST15). Specifically, reception portion 351 of terminal device 300 determines whether or not device information transmitted from MFP 100 has been received.

When terminal device 300 has not received device information from MFP 100 in step ST15 (NO in step ST15), it maintains the state until it receives the device information. Alternatively, processing for requesting device information may again be performed. Alternatively, when device information cannot be received even after lapse of a prescribed period of time, determination that preview display cannot be provided can also be made and the process can proceed to step ST4.

When terminal device 300 has received in step ST5 device information from MFP 100 (YES in step ST15), whether or not preview display can be provided is determined (step ST1). Specifically, determination portion 302 determines whether or not MFP 100 can provide preview display based on device information received by reception portion 351 of terminal device 300.

When terminal device 300 determines that preview display can be provided (YES in step ST1), a print job including an indication to carry out preview display (an MFP preview print job) is generated (step ST2). Since subsequent processing is the same as described with reference to FIG. 7, detailed description thereof will not be repeated.

In the present example, whether or not preview display can be provided can be determined, for example, by using information such as a model number of MFP 100 as device information. Specifically, a table showing correspondence between a model number and whether or not preview display can be provided may be provided in advance and then determination may be made. Alternatively, function information of terminal device 300 based on information on a model number may be obtained from a not-shown server and whether or not preview display can be provided may be determined. Alternatively, device information may include information on whether or not preview display can be provided and determination may be made based on the information. Alternatively, whether or not preview display can be provided may be determined by referring to a communication instruction for determining whether or not preview display can be provided or a management information base (MIB) value instead of device information.

With the scheme, when MFP 100 can display print preview, MFP 100 carries out print preview, and when MFP 100 cannot (is unable to) carry out print preview, print preview data created by MFP 100 is transmitted to terminal device 300 and print preview is displayed.

Namely, in carrying out preview display consistent with a printed matter, MFP 100 determines whether or not print preview can be displayed, and when print preview can be displayed, MFP 100 carries out print preview. Therefore, it is not necessary to constantly transmit print preview data to terminal device 300, and communication load on a network in preview display during direct print can be lessened.

### Second Embodiment

In the first embodiment above, a scheme for carrying out print preview when MFP 100 can display print preview has been displayed.

Print preview, however, is displayed on an apparatus different from terminal device 300, and therefore automatic display of print preview on MFP 100 may not be preferred from a point of view of security.

In a present second embodiment, display in consideration of security in displaying print preview on MFP 100 will be described.

### Operation Outlines

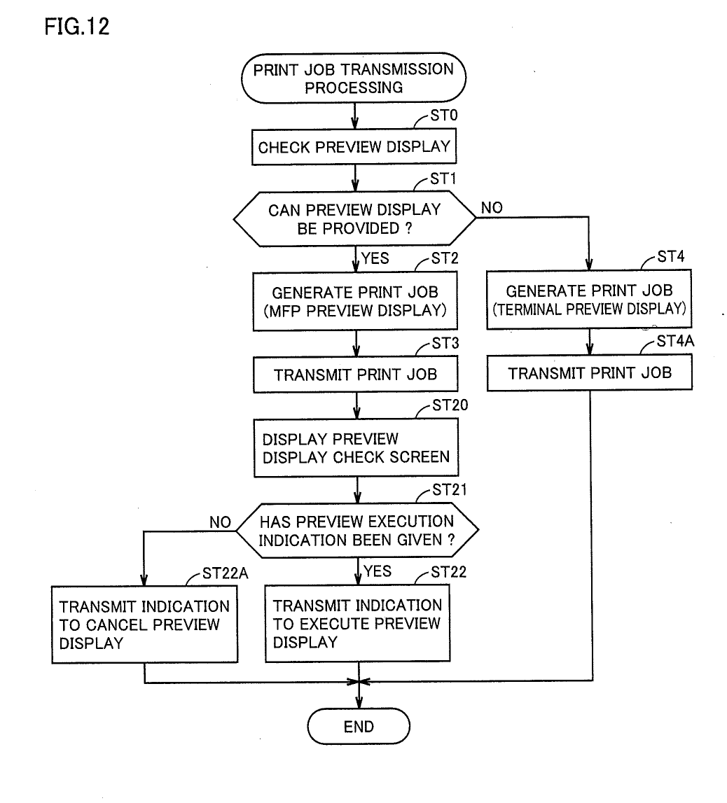

FIG. 12 is a flowchart illustrating processing for transmitting a print job in terminal device 300 based on the present second embodiment.

Referring to FIG. 12, the present process is different in additional steps ST20 to ST22A and step ST4A. Since the process is otherwise the same as described with reference to FIG. 7, detailed description thereof will not be repeated.

In step ST3, terminal device 300 transmits a print job generated in determination portion 302. Specifically, transmission portion 350 transmits an MFP preview print job created by determination portion 302 to MFP 100.

Then, terminal device 300 displays a screen for checking execution of preview display (a preview display check screen) (step ST20). Specifically, determination portion 302 instructs display control unit 304 to have a preview display check screen displayed.

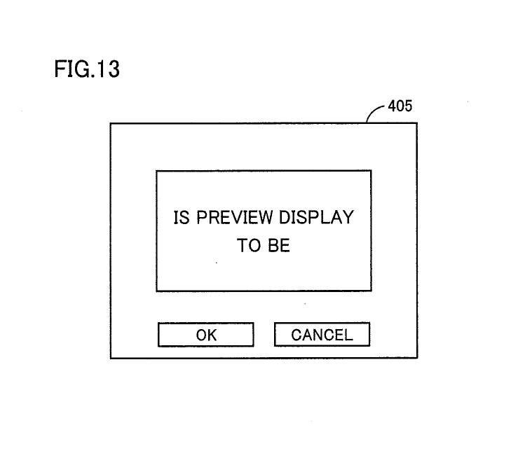

FIG. 13 is a diagram illustrating a preview display check screen based on the present second embodiment.

Referring to FIG. 13, in a preview display check screen 405, together with a message “is preview display to be carried out,” an “OK” button which is a button for transmitting an indication to carry out preview and a “cancel” button which is a button for canceling transmission of an indication to carry out preview are provided.

When the “OK” button is selected in the screen, an indication to carry out preview is transmitted from terminal device 300 to MFP 100. When the “cancel” button is selected, an indication to cancel preview execution is transmitted to MFP 100.

Referring again to FIG. 12, terminal device 300 determines whether or not an indication to carry out preview display has been given (step ST21).

When terminal device 300 determines in step ST21 that an indication to carry out preview display has been given (YES in step ST21), it transmits an indication to carry out preview display (step ST22). Specifically, transmission portion 350 transmits an indication to carry out preview by giving an indication through input apparatus 34 by means of the “OK” button displayed on preview display check screen 405.

Then, the process ends (end).

When terminal device 300 determines in step ST21 that there is no indication to carry out preview display (NO in step ST21), it transmits an indication to cancel execution of preview display (step ST22A). Specifically, transmission portion 350 transmits an indication to cancel execution of preview by giving an indication through input apparatus 34 by means of the “cancel” button displayed on preview display check screen 405.

Then, the process ends (end).

When terminal device 300 determines that preview display cannot be provided (NO in step ST1), it generates a terminal preview print job including an indication to transmit print preview data to terminal device 300 (step ST4).

Then, terminal device 300 transmits a print job generated in determination portion 302 (step ST4A). Specifically, transmission portion 350 transmits the terminal preview print job created by determination portion 302 to MFP 100. Then, the process ends (end).

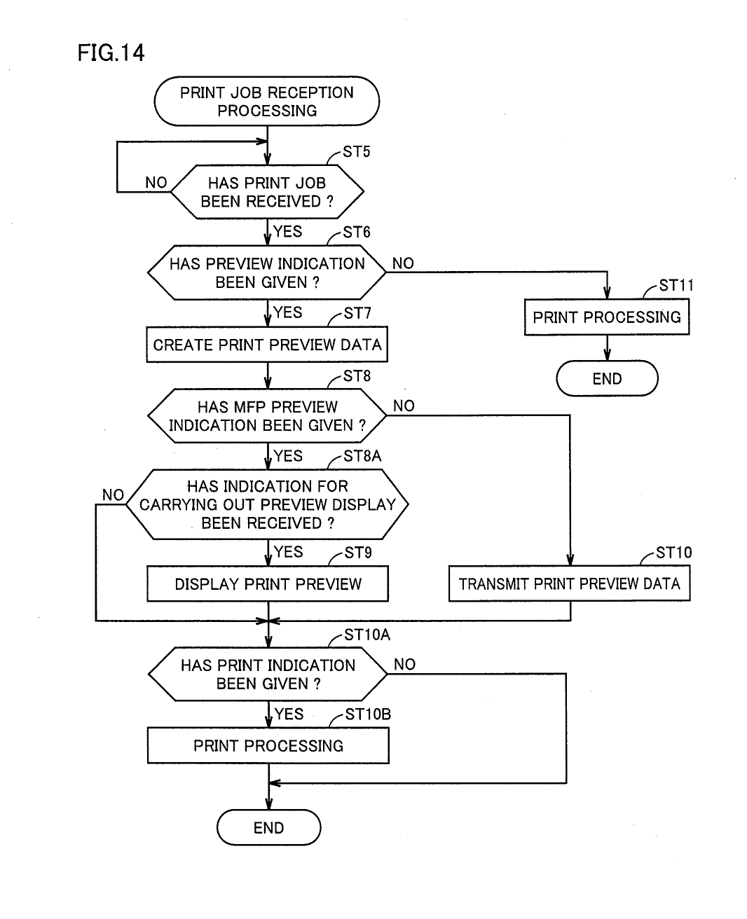

FIG. 14 is a flowchart illustrating processing for receiving a print job in MFP 100 based on the present second embodiment.

Referring to FIG. 14, the present process is different in additional step ST8A. Since the process is otherwise the same as described with reference to FIG. 9, detailed description thereof will not be repeated.

In step ST8, MFP 100 determines whether or not an indication for MFP preview has been given (step ST8). Specifically, CPU 10 determines whether or not a print job received in accordance with the included command is an MFP preview print job.

When MFP 100 determines in step ST8 that there is an indication for MFP preview (YES in step ST8), it determines whether or not an indication to carry out preview display has been received (step ST8A). Specifically, CPU 10 determines whether or not an indication to carry out preview transmitted from terminal device 300 has been received.

When MFP 100 determines in step ST8A that an indication to carry out preview display has been received (YES in step ST8A), it displays print preview (step ST9). Specifically, CPU 10 has, for example, a not-shown display portion of operation panel 16 display created print preview data. Thus, MFP 100 can display print preview and an object to be printed can be checked in advance.

Then, whether or not there is a print indication is determined (step ST10A). Specifically, CPU 10 determines whether or not an input of a print indication through operation panel 16 has been received.

When it is determined in step ST10A that there is a print indication (YES in step ST10A), print processing is performed (step ST10B). Then, the process ends (end).

When MFP 100 determines in step ST8A that an indication to carry out preview display has not been received (NO in step ST8A), that is, when an indication to cancel execution of preview has been received, the process proceeds to step ST10A. Subsequent processing is the same.

When an indication to cancel execution of preview has been transmitted from terminal device 300, print preview is not displayed on MFP 100, and for example, print preview data may be erased.

With the scheme, when print preview can be displayed on MFP 100, print preview is carried out in MFP 100, and print preview is started in response to an indication to carry out preview from terminal device 300.

Therefore, for example, after a user goes over to MFP 100, he/she can transmit an indication to carry out preview. Then, a problem that others view print preview can be avoided. For example, in preview display of a highly confidential file, print preview is displayed at timing desired by a user, so that preview display in consideration of security can be provided.

(Modification)

In the second embodiment above, an indication to carry out preview is transmitted from terminal device 300 and MFP 100 provides preview display, however, preview display can be indicated also through an operation on MFP 100 not by way of terminal device 300. Specifically, preview display check screen 405 may be displayed on a display portion of an operation panel of MFP 100.

Then, when the “OK” button is selected in the screen, preview display may be carried out. Alternatively, when the “cancel” button is selected, no print preview is displayed on MFP 100, and for example, print preview data may be erased.

### Third Embodiment

In a present third embodiment, a case that authentication information is set, and when authentication is successful, print preview is displayed on MFP 100 will be described.

### Print Setting Screen

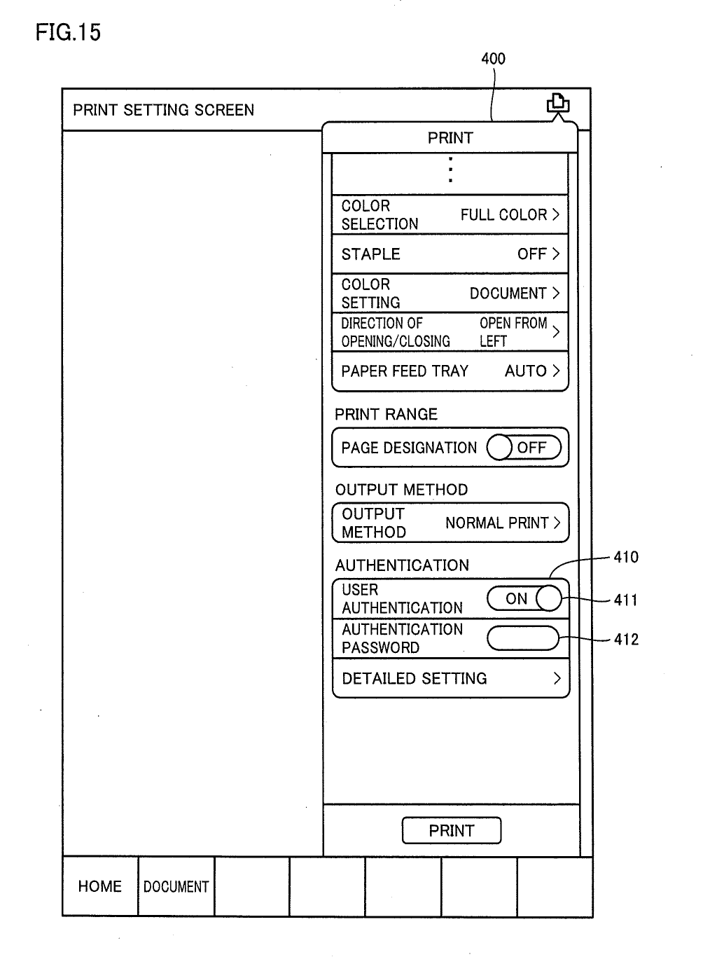

FIG. 15 is a diagram illustrating a print setting screen in carrying out direct print in the printing system based on the present third embodiment.

Referring to FIG. 15, print setting screen 400 in carrying out direct print in terminal device 300 is shown. Print setting screen 400 is displayed by execution of a program for carrying out direct print stored in ROM 31.

An authentication setting area 410 is provided in print setting screen 400, and a slide button 411 for “user authentication” is provided in authentication setting area 410. By laterally sliding the slide button, execution (on) and non-execution (off) of an authentication function can be indicated.

An area 412 for entry of an authentication password is provided, and any authentication password in performing an authentication function can be set in the area.

In the present example, execution (ON) of the authentication function is indicated by operating slide button 411, an authentication password is set, and direct print is performed.

### Operation Outlines

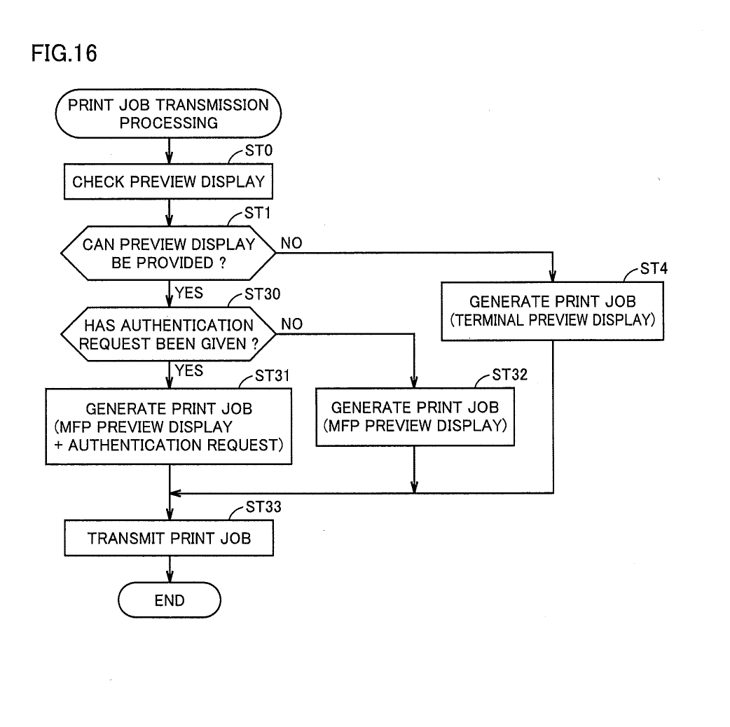

FIG. 16 is a flowchart illustrating processing for transmitting a print job in terminal device 300 based on the present third embodiment.

Referring to FIG. 16, the present process is different in additional steps ST30 to ST33 instead of steps ST2 and ST3. Since the process is otherwise the same as described with reference to FIG. 7, detailed description thereof will not be repeated.

Initially, terminal device 300 checks information on preview display on MFP 100 (step ST0).

Then, terminal device 300 determines whether or not MFP 100 which is a printing apparatus can provide preview display (step ST1).

When terminal device 300 determines in step ST1 that preview display can be provided (YES in step ST1), it determines whether or not an authentication request has been given (step ST30). Specifically, determination portion 302 determines whether or not execution of the authentication function has been indicated on print setting screen 400, and when execution of the authentication function has been indicated, it determines that there is an authentication request.

When terminal device 300 determines in step ST30 that there is an authentication request (YES in step ST30), it generates a print job including an indication to carry out preview display and requesting authentication (step ST31). Specifically, determination portion 302 generates a print job including an instruction for preview indicating execution of preview display on MFP 100 and an instruction requesting authentication. The print job includes an instruction (a command) indicating preview display on MFP 100 and an instruction indicating execution of authentication processing, together with file data to be printed. In the authentication processing, determination as to whether or not matching with an authentication password set by a user is achieved is made, and the print job includes also information on the authentication password.

Then, in step ST33, terminal device 300 transmits a print job generated in determination portion 302 (step ST33).

Then, the process ends (end).

When terminal device 300 determines in step ST30 that there is no authentication request (NO in step ST30), it generates a print job including an indication to carry out preview display (step ST32). Specifically, determination portion 302 generates a print job including an instruction for preview instructing MFP 100 to carry out preview display. The print job includes, together with file data to be printed, an instruction indicating execution of an instruction (a command) indicating preview display in MFP 100.

Then, in step ST33, terminal device 300 transmits a print job generated in determination portion 302 (step ST33).

Then, the process ends (end).

FIG. 17 is a flowchart illustrating processing for receiving a print job in MFP 100 based on the present third embodiment.

Referring to FIG. 17, the present process is different in additional steps ST40 to ST44 instead of step ST9. Since the process is otherwise the same as described with reference to FIG. 9, detailed description thereof will not be repeated.

In step ST8, MFP 100 determines whether or not an indication for MFP preview has been given. Specifically, CPU 10 determines whether or not the print job received in accordance with the command included in the print job is the MFP preview print job.

When MFP 100 determines in step ST8 that there is an indication for MFP preview (YES in step ST8), it determines whether or not there is an authentication request (step ST40). Specifically, CPU 10 determines whether or not an instruction requesting authentication in accordance with the command included in the print job is included.

When MFP 100 determines in step ST40 that there is an authentication request (YES in step ST40), it displays an authentication screen (step ST42). Specifically, when an instruction requesting authentication is included in the print job, CPU 10 has a not-shown display portion of operation panel 16 display an authentication screen.

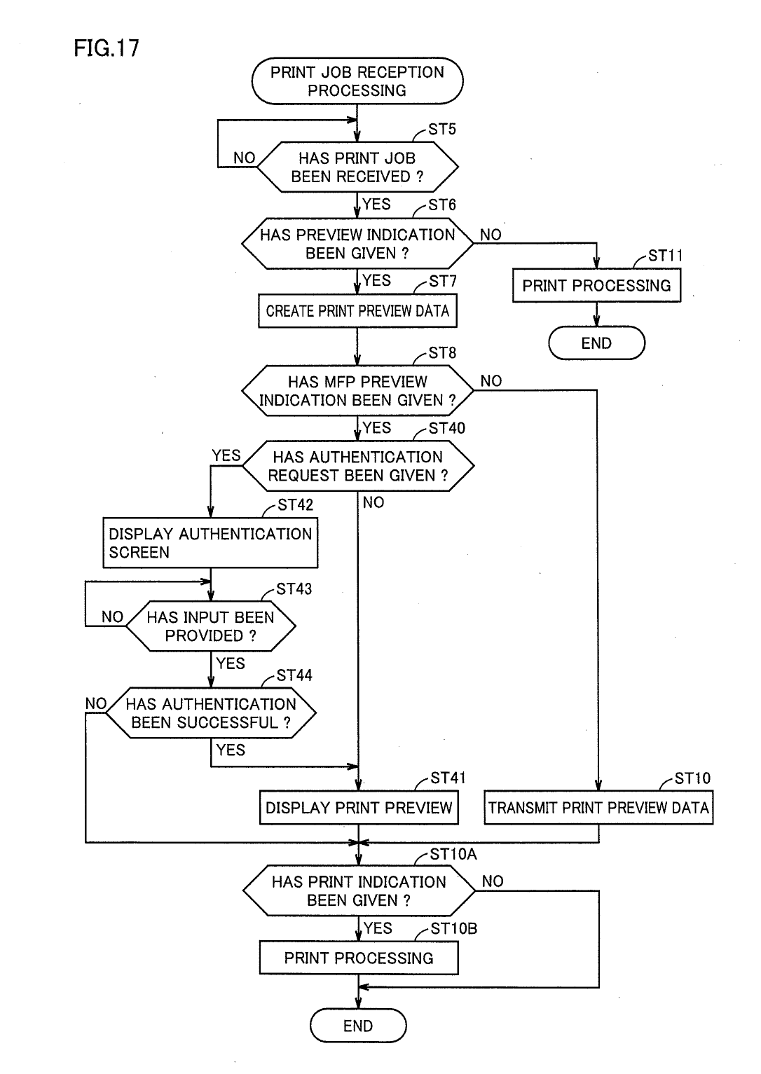

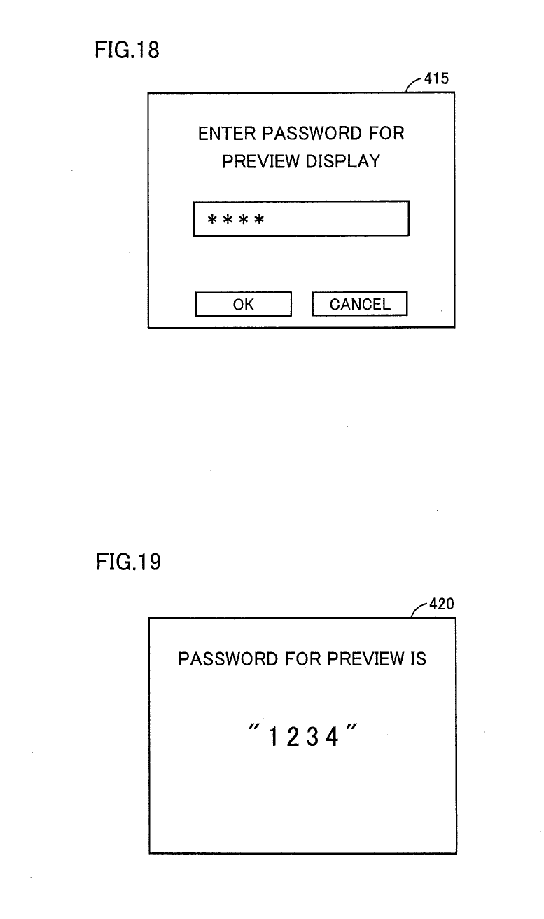

FIG. 18 is a diagram illustrating an authentication screen 415 based on the present third embodiment.

Referring FIG. 18, in authentication screen 415 based on the present third embodiment, a user can enter authentication information. In the present example, together with a representation of “enter password for preview display”, an input area is provided.

An “OK” button and a “cancel” button are provided. When an authentication password is entered and the “OK” button is selected in the screen, authentication processing is performed. Alternatively, when the “cancel” button is selected, authentication processing is canceled.

Referring again to FIG. 17, then, MFP 100 determines in step ST43 whether or not an input has been provided (step ST43). Specifically, CPU 10 determines whether or not an input from a user has been provided onto authentication screen 415.

Then, when MFP 100 determines in step ST43 that an input has been provided (YES in step ST43), it determines whether or not authentication has been successful (step ST44). Specifically, CPU 10 determines whether or not an authentication password included in a print job matches with a password entered in authentication screen 415. When matching with the authentication password is achieved, CPU 10 determines that authentication has been successful, and when matching with the authentication password is not achieved, it determines that authentication has failed.

When MFP 100 determines in step ST44 that authentication has been successful (YES in step ST44), print preview is displayed (step ST41). Specifically, CPU 10 has, for example, a not-shown display portion of operation panel 16 display created print preview data. Thus, MFP 100 can display print preview and an object to be printed can be checked in advance.

Then, whether or not there is a print indication is determined (step ST10A). Specifically, CPU 10 determines whether or not an input of a print indication through operation panel 16 has been received.

When it is determined in step ST10A that there is a print indication (YES in step ST10A), print processing is performed (step ST10B). Then, the process ends (end).

When MFP 100 determines in step ST44 that authentication has not been successful (NO in step ST44), display of print preview in step ST41 is skipped. Subsequent processing is the same. For example, print preview data may be erased.

When the “cancel” button is pressed in authentication screen 415 as well, it is determined that authentication has not been successful, that is, authentication has failed.

With the scheme, when authentication has been successful, print preview is displayed. Therefore, a problem that others view print preview can be avoided. For example, in preview display of a highly confidential file, print preview is displayed at timing desired by a user, so that preview display in consideration of security can be provided.

(First Modification)

In the form above, though a scheme that a user enters and sets authentication information in area 412 for entry of an authentication password in print setting screen 400 has been described, terminal device 300 may make setting without an input from a user.

FIG. 19 is a diagram illustrating an authentication information notification screen based on a first modification of the present third embodiment.

Referring to FIG. 19, in an authentication information notification screen 420 based on the first modification of the present third embodiment, a password set by terminal device 300 is shown. In the present example, “password for preview display is ‘1234’” is displayed.

Specifically, the authentication information notification screen may be displayed when execution (on) of the authentication function is set by using slide button 411 for user authentication on print setting screen 400. Alternatively, it may be displayed after setting in print setting screen 400.

Then, when terminal device 300 generates a print job including an instruction for preview and an instruction requesting authentication, an authentication password is included in the print job and the print job is transmitted to MFP 100. Since the process is otherwise the same as described with reference to FIG. 16, detailed description thereof will not be repeated. With the scheme, inconvenience in setting of authentication information of a user can be mitigated.

Authentication information set by terminal device 300 may be determined by using a random number, or data registered in advance by a user in terminal device 300 may be made use of for setting. For example, data used for locking terminal device 300 may also be set as authentication information. Alternatively, when terminal device 300 has a telephone function, at least a part of a telephone number allocated to the telephone function may also be made use of.

Though a scheme for displaying a password for preview display for recognition by a user has been described in the present example, security can further be enhanced by not displaying the password when data registered in advance by the user in terminal device 300 is made use of.

(Second Modification)

In another scheme, a job for preview transmitted from terminal device 300 can also be stored in a prescribed area having a security function in MFP 100.

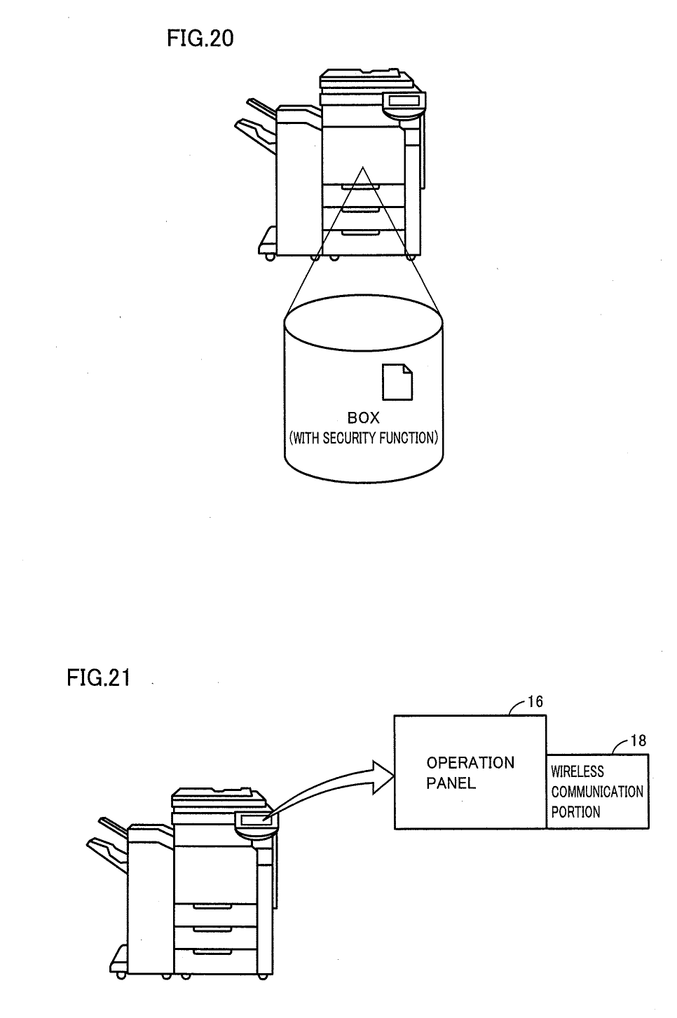

FIG. 20 is a diagram illustrating a BOX area which is a prescribed area of MFP 100.

Referring to FIG. 20, information can be stored in what is called a BOX area of HDD 13 of MFP 100. In accessing the BOX area, authentication processing is necessary. In the present example, a job for preview and authentication information are received in MFP 100. Communication controller 17 in MFP 100 receives an MFP preview print job including an instruction requesting authentication and has the MFP preview print job stored in the BOX area.

According to such a configuration, authentication processing is requested for access to the BOX area, and for example as described with reference to FIG. 18, an entry screen for entry of authentication information is displayed and an entry from a user is accepted.

When MFP 100 accepts an entry of authentication information from a user and authentication has been successful, the print job is accessed and preview display can be provided. MFP 100 requests entry of authentication information as an indication for start of print preview in connection with a print job stored in the BOX area through operation panel 16, and when authentication processing has been successful, MFP 100 has the display portion of operation panel 16 display print preview in accordance with the print job stored in the BOX area.

With the scheme, when print preview is not displayed immediately, that is, when print preview is desired to be checked later, the print job can be stored in a storage area where a print job can be stored and execution of print preview can be indicated at appropriate timing.

(Third Modification)

Though a case that information input by a user, data registered in advance, or created information is made use of as authentication information has been described above, information specifically owned by terminal device 300 can also be made use of.

In the present example, a scheme for performing authentication processing by bringing terminal device 300 closer to MFP 100 will be described.

FIG. 21 is a diagram illustrating a wireless communication portion provided in the vicinity of the operation panel of MFP 100.

Referring to FIG. 21, in the present example, a wireless communication portion 18 provided to be able to communicate with terminal device 300 is provided in the vicinity of operation panel 16. Wireless communication portion 18 is provided to be capable of near field communication with terminal device 300.

Wireless communication portion 18 is provided to be capable of communication as it transmits a beacon signal to a device within a prescribed range and the device capable of wireless communication which has received the beacon signal replies to wireless communication portion 18. Wireless communication portion 18 can obtain information on a device through wireless communication.

### Operation Outlines

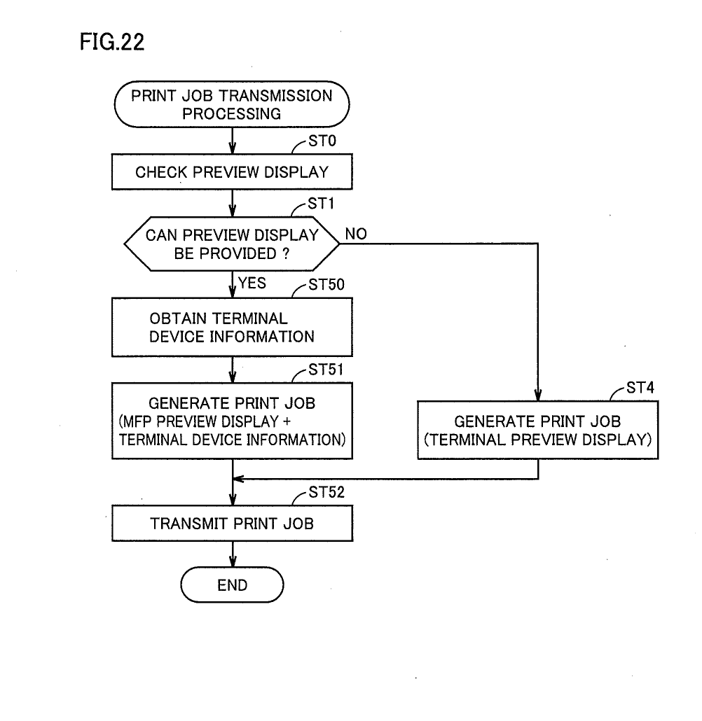

FIG. 22 is a flowchart illustrating processing for transmitting a print job in terminal device 300 based on the third modification of the present third embodiment.

Referring to FIG. 22, the present process is different in additional steps ST50 to ST52 instead of steps ST2 and ST3. Since the process is otherwise the same as described with reference to FIG. 7, detailed description thereof will not be repeated.

When terminal device 300 determines in step ST1 that preview display can be provided, terminal device 300 obtains terminal device information (step ST50). The terminal device information refers to an identification number used for identifying a terminal such as a serial number specific to the terminal.

Then, in step ST51, terminal device 300 generates a print job including an indication to carry out preview display and requesting authentication (step ST51). Specifically, determination portion 302 generates a print job including an instruction for preview indicating execution of preview display on MFP 100 and an instruction requesting authentication. The print job includes, together with file data to be printed, an instruction (a command) indicating preview display on MFP 100 and an instruction indicating execution of authentication processing. In the authentication processing, whether or not terminal device information included in the print job matches with information on a device of a terminal apparatus which is carried by a user and communicates through wireless communication portion 18 is determined. The print job includes also terminal device information.

Then, terminal device 300 transmits a print job generated in determination portion 302 (step ST52).

Then, the process ends (end).

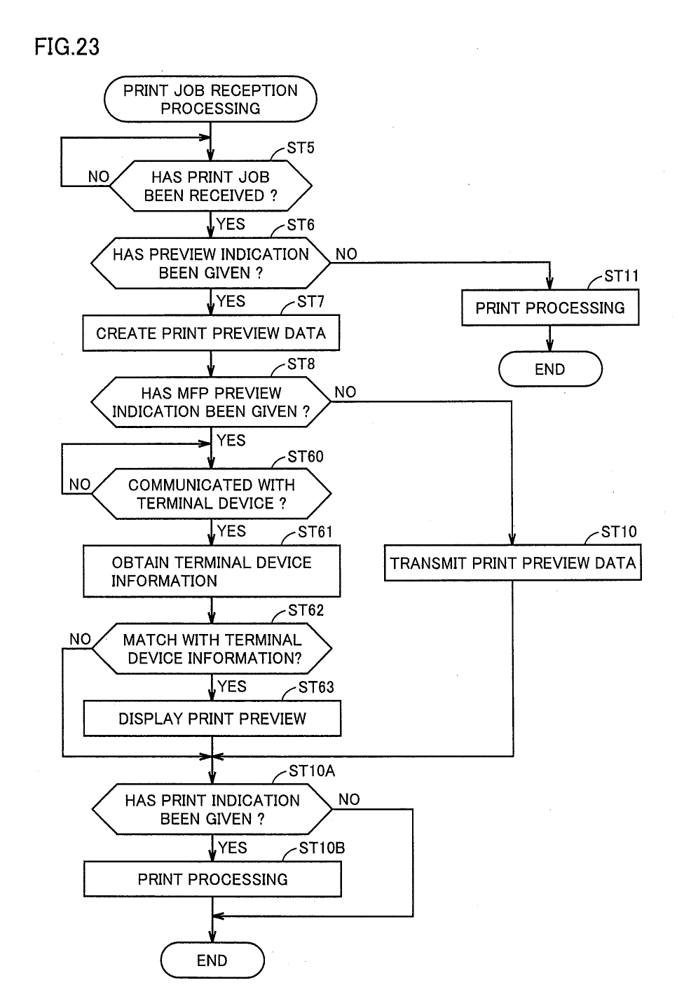

FIG. 23 is a flowchart illustrating processing for receiving a print job in MFP 100 based on the third modification of the present third embodiment.

Referring to FIG. 23, the present process is different in additional steps ST60 to ST63 instead of step ST9. Since the process is otherwise the same as described with reference to FIG. 9, detailed description thereof will not be repeated.

MFP 100 determines in step ST8 whether or not there is an indication for MFP preview (step ST8). Specifically, CPU 10 determines whether or not the print job received in accordance with the command included in the print job is the MFP preview print job.

When MFP 100 determines in step ST8 that there is an indication for MFP preview (YES in step ST8), it determines whether or not it has communicated with a terminal device. Specifically, whether or not near field communication between wireless communication portion 18 and terminal device 300 has been carried out is determined.

When MFP 100 determines in step ST60 that it has communicated with terminal device 300 (YES in step ST60), it obtains terminal device information from the terminal device with which it has communicated (step ST61). The state is maintained until communication with the terminal device in step ST60.

Then, MFP 100 determines matching (step ST62). Specifically, CPU 10 determines whether or not terminal device information included in the print job matches with terminal device information obtained from the terminal device with which CPU 10 communicated through wireless communication portion 18.

Then, when MFP 100 determines in step ST62 that the terminal device information included in the print job matches with terminal device information obtained from the terminal device (YES in step ST62), print preview is displayed (step ST63). Specifically, CPU 10 has, for example, a not-shown display portion of operation panel 16 display created print preview data. Thus, MFP 100 can display print preview and an object to be printed can be checked in advance.

Then, whether or not there is a print indication is determined (step ST10A). Specifically, CPU 10 determines whether or not an input of a print indication through operation panel 16 has been received.

When it is determined in step ST10A that there is a print indication (YES in step ST10A), print processing is performed (step ST10B). Then, the process ends (end).

When MFP 100 determines in step ST62 that the terminal device information included in the print job dose not match with terminal device information obtained from the terminal device (NO in step ST62), print preview in step ST63 is skipped. Subsequent processing is the same. For example, print preview data may be erased.

With the scheme, print preview is displayed when the terminal device information included in the print job matches with terminal device information obtained from the terminal device. Therefore, a problem that others view print preview can be avoided. For example, in preview display of a highly confidential file, print preview is displayed at timing desired by a user, so that preview display in consideration of security can be provided.

With the scheme, since authentication processing can be performed by a terminal device, for example, it is not necessary to store a password and user's convenience is high.

### Fourth Embodiment

In the above, when MFP 100 determines that print preview can be provided, terminal device 300 generates an MFP preview print job and transmits the MFP preview print job to MFP 100. Alternatively, a user can also be allowed to select on which apparatus display is to be provided.

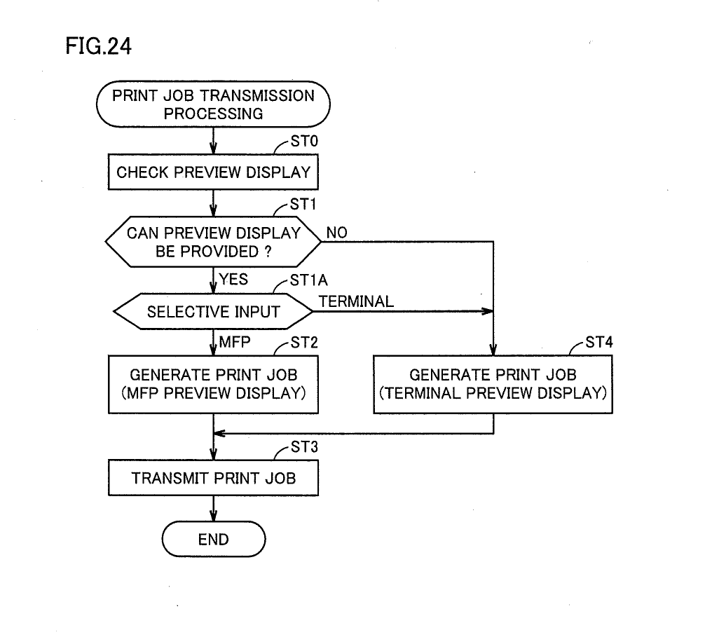

FIG. 24 is a flowchart illustrating processing for transmitting a print job in terminal device 300 based on a present fourth embodiment.

Referring to FIG. 24, the present printing system is different in additional step ST1A. Since the printing system is otherwise the same as described with reference to FIG. 7, detailed description thereof will not be repeated.

When terminal device 300 determines that preview display can be provided, it accepts a selective input (step ST1A). Specifically, a user is allowed to select on which device print preview is to be displayed. MFP 100 may display a screen showing is print preview to be displayed, and a selective input from a user may be accepted.

Then, when terminal device 300 selects an MFP in response to a selective input from a user (MFP in step ST1A), the process proceeds to step ST2 and processing the same as described above is performed subsequently.

When terminal device 300 selects a terminal device in response to a selective input from a user (terminal in step ST1A), the process proceeds to step ST4 and processing the same as described above is performed subsequently.

With the scheme, the user is allowed to select print preview, which is convenient for a user.

### Other Forms

In connection with the form above, a configuration in coordination with a server can also be applicable.

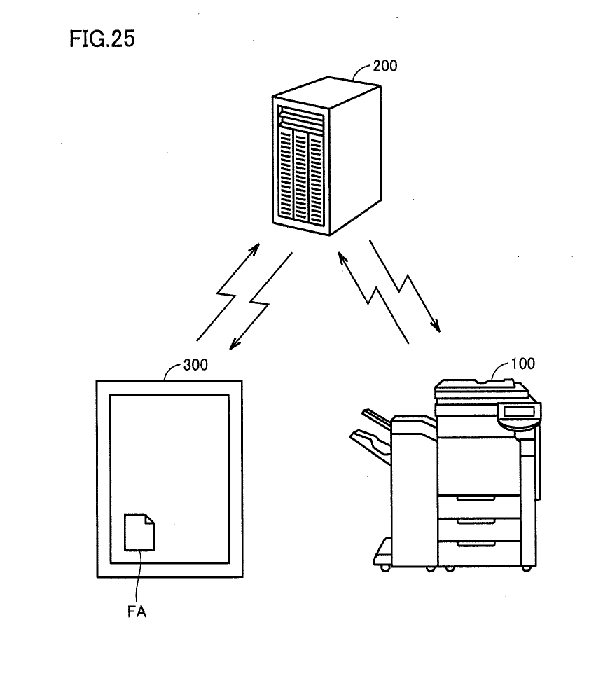

FIG. 25 is a diagram illustrating a printing system in coordination with a server.

Referring to FIG. 25, a server 200 is provided between MFP 100 and terminal device 300. Specifically, server 200 communicates data with terminal device 300 and MFP 100.

Server 200 holds a job for preview received from terminal device 300 and transmits the job to a printer in response to an indication. The indication may be an indication from terminal device 300 or an indication from MFP 100, or a scheme for transmission to MFP 100 when prescribed time comes can also be applicable.

### Other Examples

In addition, a program for causing CPU 30 of terminal device 300 to perform the operation described above can also be provided. Such a program can be recorded on a computer-readable recording medium such as a flexible disk, a CD-ROM (Compact Disk-Read Only Memory), a ROM, a RAM, and a memory card adapted to a computer, and can be provided as a program product. Alternatively, the program can also be recorded and provided in a recording medium such as a hard disk contained in the computer. Further, the program can also be provided by downloading through the network.

The program may execute the processing by calling a necessary module out of program modules provided as a part of an operating system (OS) of the computer, in a prescribed sequence and at prescribed timing. In such a case, the program itself does not include the module above but executes the processing in cooperation with the OS. Such a program not including the module may also be encompassed in the program according to the present disclosure.

Alternatively, the program according to the present disclosure may be provided in a manner incorporated as a part of another program such as an application for direct print or an application for preview display, or may be provided as a program different from such a program. In such a case as well, the program itself does not include the module included in another program, but the program executes the processing in cooperation with another program. Such a program incorporated in another program may also be encompassed in the program according to the present disclosure.

The provided program product is installed in a program storage portion such as a hard disk for execution. It is noted that the program product includes the program itself and the recording medium recording the program.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A printing system, comprising:
a printer; and
a terminal device provided to be able to communicate with said printer and transmitting a print job relating to print processing for a file which can be supported by said printer,
said terminal device including
a controller determining whether print preview can be displayed on a display of said printer, and
a communication controller transmitting to said printer, a print job including an indication for said print preview in response to an indication when said controller determines that said print preview can be displayed on said display of said printer,
said printer displaying on said display, print preview in accordance with the print job including the indication for said print preview transmitted from said terminal device.

2. The printing system according to claim 1, wherein
said printer displays said print preview on said display in response to an input of the indication for start of said print preview.

3. The printing system according to claim 2, wherein
said printer displays said print preview on said display in response to the input of the indication for start of said print preview from said terminal device.

4. The printing system according to claim 2, wherein
said printer displays said print preview on said display in response to the input of the indication for start of said print preview onto an input portion of said printer.

5. The printing system according to claim 4, wherein
the print job including the indication for said print preview transmitted from said terminal device is stored in a prescribed area of said printer, access to which requires authentication processing, and
said printer requests input of authentication information as the indication for start of said print preview onto the input portion of said printer, and displays said print preview on said display in accordance with the print job including the indication for said print preview stored in said prescribed area when said authentication processing is successful.

6. The printing system according to claim 4, wherein
the print job including the indication for said print preview includes identification information identifying said terminal device which has transmitted the print job including the indication for the print preview,
the input portion of said printer has a wireless communication portion provided to be capable of near field communication with said terminal device and obtaining identification information identifying said terminal device through said near field communication, and
said printer determines whether the obtained identification information of the terminal device matches with the identification information identifying said terminal device included in the print job including the indication for said print preview, and displays said print preview on said display in accordance with the print job including the indication for said print preview transmitted from said terminal device when the printer determines that the obtained identification information matches with the identification information included in the print job.

7. The printing system according to claim 4, wherein
said communication controller transmits to said printer, the print job including the indication for said print preview associated with authentication information made use of for authentication processing in response to an indication when the communication controller determines that said print preview can be displayed on said display of said printer, and
said printer requests input of said authentication information as the indication for start of said print preview onto the input portion of said printer and displays said print preview on said display when said authentication processing is successful.

8. The printing system according to claim 7, wherein
said terminal device generates and displays password information requested in said authentication processing.

9. The printing system according to claim 8, wherein
said password information is data registered in advance by a user in said terminal device.

10. The printing system according to claim 1, wherein
the controller of said terminal device accepts a selective input about whether said print preview is displayed on said display of said printer or said print preview is displayed based on a display function of said terminal device,
said communication controller transmits to said printer, the print job including the indication for said print preview, with information indicating display of said print preview based on the display function of said terminal device being included, when said controller accepts display of said print preview based on the display function of said terminal device, and
said printer generates print preview data for display of said print preview in accordance with said information included in the print job including the indication for said print preview transmitted from said terminal device and transmits said print preview data to said terminal device for display of said print preview based on the display function of said terminal device.

11. The printing system according to claim 1, further comprising a server provided to be able to communicate with the printer and said terminal device, holding the print job including the indication for said print preview transmitted from said terminal device to said printer, and transmitting the print job to said printer in response to an indication.

12. A terminal device provided to be able to communicate with a printer and transmitting a print job relating to print processing for a file which can be supported by said printer, comprising:
a controller determining whether print preview can be displayed on a display of said printer; and
a communication controller transmitting a print job including an indication for said print preview to said printer in response to an indication when said controller determines that said print preview can be displayed on said display of said printer.

13. A printer provided to be able to communicate with a terminal device and receiving from said terminal device, a print job relating to print processing for a file which can be supported, comprising:
a display; and
a controller displaying said print preview on said display in accordance with a print job including an indication for said print preview transmitted from said terminal device when it is determined that said terminal device can display the print preview on said display.
